(19) United States
(12) Patent Application Publication
(10) Pub. No.: US 2012/0058418 A1
(43) Pub. Date: Mar. 8, 2012

(54) THREE-DIMENSIONAL HOLOGRAPHIC DISPLAY DEVICE

(75) Inventors: Peng Wang, San Diego, CA (US); Michiharu Yamamoto, Carlsbad, CA (US); Padiyar Devanna Dinesh, San Marcos, CA (US)

(73) Assignee: NITTO DENKO CORPORATION, Ibaraki, Osaka (JP)

(21) Appl. No.: 13/318,551

(22) PCT Filed: May 27, 2010
(86) PCT No.: PCT/US10/36411

§ 371 Date: Nov. 2, 2011

Related U.S. Application Data
(60) Provisional application No. 61/184,208, filed on Jun. 4, 2009.

(51) Int. Cl. G03H 1/04; G03H 1/26; G03H 1/22

(52) U.S. Cl. 430/2; 359/3; 359/4

(57) ABSTRACT

A three-dimensional holographic display device includes a holographic display medium constituted by a photorefractive organic composition, and an optical system for recording and reproducing a holographic image using the holographic display medium. The photorefractive organic composition includes a photorefractive organic polymer having a tri-alkyl amino side-chain group.

### CROSS-REFERENCE TO RELATED APPLICATIONS

This application is the U.S. National Phase under 35 U.S.C. §371 of International Application PCT/US2010/036411, filed on May 27, 2010, which claims priority to U.S. Provisional Patent Application No. 61/184,208, filed Jun. 4, 2009, the disclosure of which is incorporated herein by reference in its entirety. The International Application was published under PCT Article 21(2) in English.

### BACKGROUND OF THE INVENTION

1. Field of the Invention

The present invention relates to three-dimensional holographic display devices comprising a holographic display medium which is prepared by a composition comprising a photorefractive organic polymer having a tri-alkyl amino side-chain group. Also, the present invention is related to new holographic image recording and reading methods using two or more independent color laser beams, preferably three RGB (Red/Green/Blue) lasers.

2. Description of the Related Art

Demand for various kinds of photonics devices with higher performance and better processing, and which are more compact is constantly increasing. The ease of device fabrication has been increased due to the recent and rapid developments of information communication technology. In order to meet this demand, a lot of interest has been focused on R&D studies for photonics devices made of organic materials. Organic materials have more varieties of compositions, low dielectric constants, low cost, light weight, and exhibit structural flexibility, a sufficiently long shelf life, high optical quality, and thermal stability, as well as ease of device fabrication.

Conventionally, for this purpose, photorefractive inorganic crystals, such as BaTiO₃, LiNbO₃, Bi₁₂SiO₂₀, Bi₁₂GeO₂₀, InP, GaAs, GaP, and CdTe, have been used, and are disclosed in Japanese Patent Application Laid-open No. 2000-162949, for example.

Photo refractivity is a phenomenon in which the refractive index of a material can be altered by changing the electric field within the material, such as by intense laser beam irradiation. The change of refractive index is achieved by a series of steps, including: (1) two laser beam interference and formation of diffraction grating as shown in FIG. 1a, (2) charge generation by diffraction grating as shown in FIG. 1b, (3) charge transfer, resulting in separation of positive and negative charges as shown in FIG. 1c, (4) trapping of one type of charge (charge delocalization), (5) formation of a non-uniform internal electric field (space-charge field) as a result of charge delocalization as shown in FIG. 1d, and (6) refractive index change induced by the non-uniform electric field as shown in FIG. 1e. Phase difference Φ can be given, as deviation of spatial charge distribution is electric field.

That is, optical intensity distribution of laser interference grating can be recorded as refraction index distribution. Unlike the photographic type hologram recording method, development and imprinting processes are not required and real-time recording/reading-out/erasing are possible, as the formed refractive index grating is coming from a real-time spatial electric field.

Also, another feature of the photorefractive effect, a phase difference Φ can be formed between the interference grating and the refractive index grating, which can give optical amplification with assistance of a self-diffraction effect. For instance, with two beam coupling cases, if the phase difference is Φ=π/2, the intensity of one transmitted signal beam is increased by the effect of another pump beam. Original beam intensity is amplified. This phenomenon can be utilized as an amplified optical function in the coherent optical information processing arena.

Therefore, good photorefractive properties can be seen only for materials that combine good charge generation, good charge transfer, or photoconductivity, and good electro-optical activity.

By irradiating intense laser beam into the photorefractive phenomenon material, its refractive index can be altered. Once laser irradiation stops, the refractive index can return to the original index. These unique properties can be applied to various kinds of photonics devices.

In order to get good photorefractive effects, as explained in the principle of photo refractivity previously, photorefractive compositions should have the following functions; (1) ability to generate a photo-electron (photo-sensitizer part), (2) charge transferability (to carry the generated hole effectively), and (3) nonlinear optical ability to give electro-optical effects. (Pockels effect).

Originally, the photorefractive effect was found in a variety of inorganic electro-optical (EO) crystals, such as BaTiO₃, LiNbO₃, Bi₁₂SiO₂₀, Bi₁₂GeO₂₀, InP, GaAs, GaP, and CdTe. In these materials, the mechanism of the refractive index modulation by the internal space-charge field is based on a linear electro-optical effect. Further studies and applications for photorefractive devices are still continuing.

In 1990 and 1991, the first organic photorefractive crystal and polymeric photorefractive materials were discovered and reported. Such materials are disclosed, for example, in U.S. Pat. No. 5,064,264, to Ducharme et al. Organic photorefractive materials offer many advantages over the original inorganic photorefractive crystals, such as large optical nonlinearities, low dielectric constants, low cost, light weight, structural flexibility, and ease of device fabrication. Other important characteristics that may be desirable depending on the application include sufficiently long shelf life, high optical quality, and thermal stability. These kinds of active organic polymers are emerging as key materials for advanced information and telecommunication technology.

In recent years, efforts have been made to optimize the properties of organic, and particularly polymeric, photorefractive materials. As mentioned above, good photorefractive properties depend upon good charge generation, good charge transfer, also known as photoconductivity, and good electro-optical activity. Various studies that examine the selection and combination of the components that give rise to each of these features have been done. Incorporating materials containing carbazole groups frequently provides the photoconductive capability. Phenyl amine groups can also be used for the charge-transfer part of the material.

Recently, organic photorefractive compositions, which show fast response times, high diffraction efficiencies, and good stabilities, were also disclosed by the inventors.

3D display technology is attracting much public attention with the recent release of movies such as “Avatar”, CNN 2008 election-night “hologram” reporter interviews, and the demonstration of 3D television by some manufacturers. It has repeatedly been proven that with holography, and its ability to provide both intensity and phase information of a scene, the brain is not fooled by an illusion of an object, but rather perceives light as it would have been scattered from the real object itself if the object had existed. Furthermore, there is no need for any special eyewear to be worn by the observer. However, due to lack of rewritable materials so far there is no practical updatable 3D true color holographic display reported. H. Bjelkhagen et. al. reported most recent progress in color holography in Applied Optics, 2008, 47, A123. Highly realistic 3D images were produced using a silver halide plate. However, those 3D images are recorded once and lack dynamic updating capability due to the material properties. S. Tay et al. reported in Nature, 2008, 451, 694 an updatable holographic 3D display based on integral holography technique using photorefractive polymeric materials. This was the first updatable 3D holographic display demonstration. However, only one laser (green) was used in their system, so only monocolor image could be observed. In some embodiments of the present invention, three color lasers are combined in a recording system along with rewritable photorefractive media. In some embodiments, an object beam is emitted from a combined white laser source, and three different color reference beams having different incident angles are adopted. Also, in the system, a digital micromirror device and an LCD plate or Spatial light modulator (SLM) are employed for image data input. Consequently, updatable, highly realistic, true color 3D holographic display are demonstrated.

### SUMMARY OF THE INVENTION

One embodiment of the invention relates to a three-dimensional holographic display device comprising a holographic display medium constituted by a photorefractive organic composition, and an optical system for recording and reproducing a holographic image using the holographic display medium, said photorefractive organic composition comprising at least one photorefractive organic polymer having a tri-alkyl amino side-chain group, wherein the tri-alkyl amino side-chain group is selected from the group consisting of the structure shown in general formula group 1:

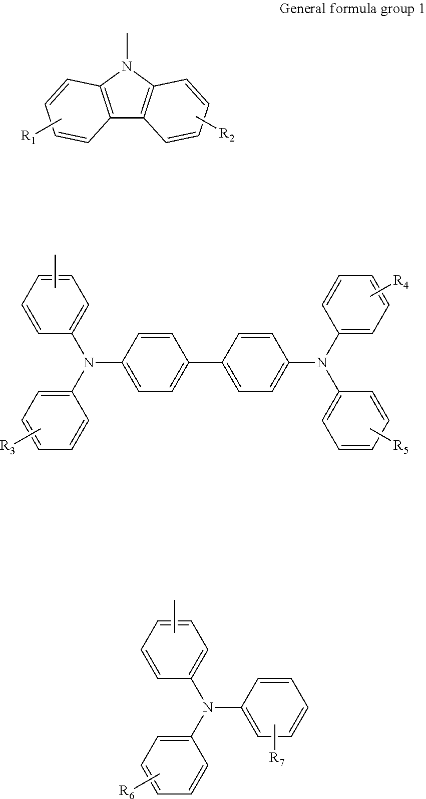

wherein R₁, R₂, R₃, R₄, R₅, R₆, and R₇ are each independently selected from the group consisting of a hydrogen atom, a linear alkyl group with up to 10 carbons, a branched alkyl group with up to 10 carbons, a linear alkyloxy group with up to 10 carbons, a branched alkyloxy group with up to 10 carbons, and an aromatic group with up to 10 carbons.

In a preferred embodiment, holographic images can be recorded by two or more different color laser beams.

In another preferred embodiment, the two or more laser beams are selected from the group consisting of red, green, and blue color laser beams.

In another preferred embodiment, the holographic images can be recorded by image data which can be input through a spatial light modulator, liquid crystal plate or digital micromirror device. In another preferred embodiment, the optical system comprises laser sources for emitting the two or more different color laser beams.

In another preferred embodiment, the optical system further comprises a spatial light modulator, liquid crystal plate or digital micromirror device for outputting image data to record the holographic image on the holographic display medium.

In another preferred embodiment, the photorefractive organic composition has a ratio of a unit having charge transfer ability to a unit having non-linear optical ability which is between about 4/1 and 1/4 by weight.

Another embodiment of the invention relates to a method of recording and reproducing a holographic image comprising:

(i) recording a holographic image using an optical system by illuminating an object laser beam and at least one reference laser beam (e.g., two, three, or more laser beams) onto a holographic display medium while a bias voltage is applied thereto, said holographic display medium constituted by a photorefractive organic composition,

said photorefractive organic composition comprising at least one photorefractive organic polymer having a tri-alkyl amino side-chain group, wherein the tri-alkyl amino side-chain group is selected from the group consisting of the structure shown in general formula group 1:

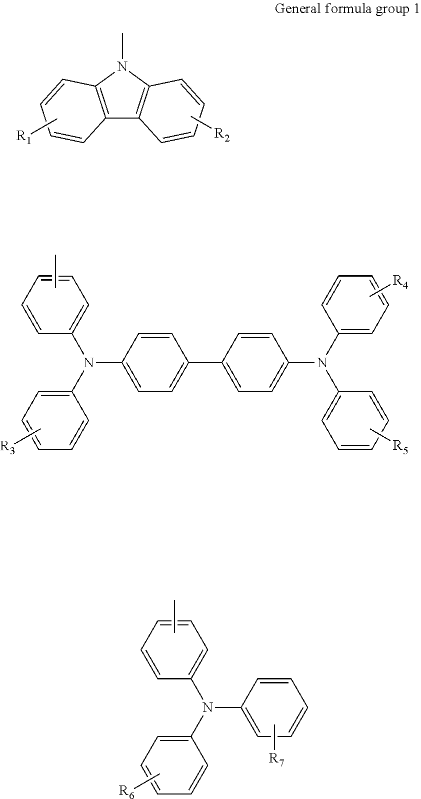

wherein R₁, R₂, R₃, R₄, R₅, R₆, and R₇ are each independently selected from the group consisting of a hydrogen atom, a linear alkyl group with up to 10 carbons, a branched alkyl group with up to 10 carbons, a linear alkyloxy group with up to 10 carbons, a branched alkyloxy group with up to 10 carbons, and an aromatic group with up to 10 carbons; and

(ii) reproducing the holographic image using said optical system by illuminating at least one reference laser beam (e.g., two, three, or more laser beams) onto the holographic display medium.

In a preferred embodiment, the holographic image is recorded and reproduced using two or more different color laser beams.

In another preferred embodiment, the two or more laser beams are selected from the group consisting of red, green, and blue color laser beams.

In another preferred embodiment, the holographic image is recorded by outputting image data through a spatial light modulator, liquid crystal plate or digital micromirror device.

For purposes of summarizing aspects of the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention. The drawings are oversimplified for illustrative purposes and are not necessarily to scale.

FIGS. 1a-1e illustrate the principle of photo refractivity.

FIG. 1a illustrates two laser beam interference and formation of diffraction grating.

FIG. 1b illustrates charge generation by diffraction grating.

FIG. 1c illustrates charge transfer which results in separation of positive and negative charges.

FIG. 1d illustrates formation of a non-uniform internal electric field (space-charge field) as a result of charge delocalization.

FIG. 1e illustrates refractive index change induced by the non-uniform electric field.

FIG. 2 is a schematic illustration showing a first exemplary configuration of a holographic display device as an embodiment of the present invention.

FIG. 3 is a schematic illustration showing a second exemplary configuration of a holographic display device as an embodiment of the present invention.

FIG. 4 is a schematic illustration showing a third exemplary configuration of a holographic display device as an embodiment of the present invention.

FIG. 5 is a schematic illustration showing a fourth exemplary configuration of a holographic display device as an embodiment of the present invention.

FIG. 6 is a schematic illustration showing a laser beam arrangement for the first exemplary configuration and the third exemplary configuration of a holographic display device as an embodiment of the present invention.

FIG. 7 is a schematic illustration showing a laser beam arrangement for the second exemplary configuration and the fourth exemplary configuration of a holographic display device according to an embodiment of the present invention.

FIG. 8 is a schematic illustration showing a fifth exemplary configuration of a holographic display device as an embodiment of the present invention.

FIG. 9 is a schematic illustration showing a sixth exemplary configuration of a holographic display device as an embodiment of the present invention.

FIG. 10 is a schematic illustration showing a seventh exemplary configuration of a holographic display device as an embodiment of the present invention.

FIG. 11 is a schematic illustration showing an eighth exemplary configuration of a holographic display device as an embodiment of the present invention.

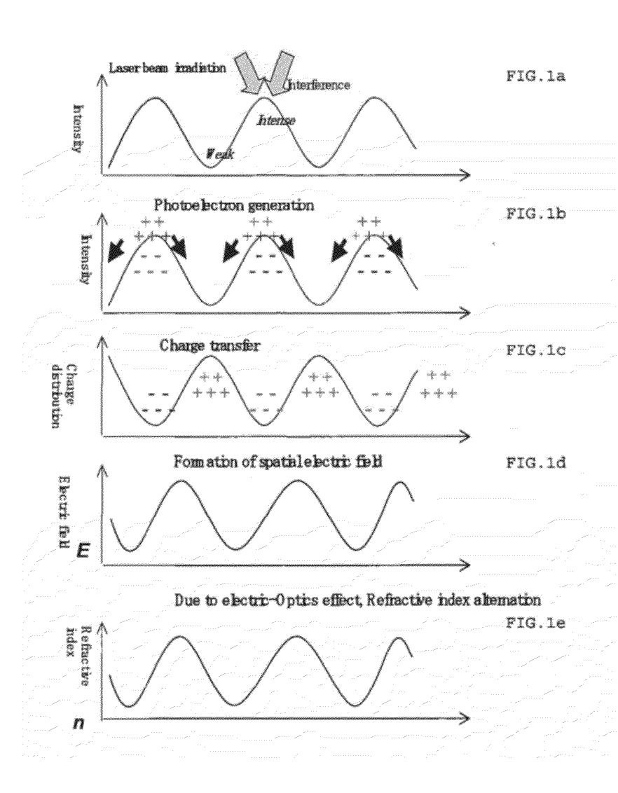

### DESCRIPTION OF SYMBOLS

1: Blue laser
2: Green laser
3. Red laser
4: Half minor
5: Dichroic half mirror
6: Dichroic half mirror
7: Half-wave plate
8: Mirror
9: Mirror
10: Mirror
11: 3D object
12: Spatial filter
13: Collimating mirror
14: Spatial filter
15: Collimating mirror
16: Mirror
17: Spatial filter
18: Collimating mirror
19: Spatial filter
20: Photorefractive medium (holographic display medium)
21: Mirror
22: Mirror
23: High voltage supplier
24: Observation position
25: Moveable Mirror
26: Spatial light modulator, Liquid crystal plate or Digital micromirror device
27: Spatial light modulator control device, Liquid crystal plate control device or Digital micromirror device control device
28: Mirror
29: Beam shutter
30: Object beam
31: Blue reference beam
32: Green reference beam
33: Red reference beam
34: Half-wave plate
35: Half-wave plate
36: Half-wave plate
101: Blue laser
102: Green laser
103: Red laser
104: Mirror
105: Dichroic minor
106: Dichroic minor
107: Half-wave plate
108: Beam splitter
109: Mirror
110: Spatial filter
111: 3D object
112: Spatial filter
113: Collimating mirror
114: Mirror
115: Photorefractive medium
116: High voltage supplier
117: Beam shutter
118: Observation position
119: Object beam
120: Reference beam
121: Holographic object light
122: Spatial light modulator
123: Spatial light modulator control device
124: Mirror

### DETAILED DESCRIPTION OF THE PREFERRED EMBODIMENT

In order to write holograms, an object beam (or a signal beam) and at least one reference beam are required. The object beam carries information to be stored in a hologram and can be either reflected off an object being recorded or sent through e.g., a transparency or a spatial light modulator, into a medium.

In an embodiment, a three-dimensional holographic display device may comprise a holographic display medium formed from any of the polymer compositions (photorefractive organic polymer compositions) disclosed herein and an optical system for recording and reproducing a holographic image using the holographic display medium. In an embodiment, the optical system may further comprise a spatial light modulator, liquid crystal plate or digital micromirror for outputting image data to record the holographic image on the holographic display medium. In an embodiment, the holographic display device may comprise: (i) any of the holographic display medium disclosed herein; (ii) a laser optical system for emitting an object beam and three reference beams for recording an image or emitting three reference beams for reproducing the image onto the holographic display medium; and (iii) an electric system for applying electric voltage to the holographic display medium. The laser optical system may comprise a laser source, a minor, a beam splitter, and a spatial filter, and the electric system may comprise a high voltage supplier.

The holographic display medium may be sheet-shaped or planary and may have a thickness of about 50 μm to about 100 μm in an embodiment. The holographic display medium can be obtained by heating and melting powder of any of the polymer compositions (photorefractive organic compositions) disclosed herein in a desired configuration and size. The holographic display medium may be equipped with electrodes for applying voltage thereto. Further, in an embodiment, the holographic display medium can be laminated with one or more other films such as an anti-glare film.

In the present disclosure where conditions and/or structures are not specified, the skilled artisan in the art can readily provide such conditions and/or structures, in view of the present disclosure, as a matter of routine experimentation. For example, monomers, copolymerization processes, and other compounds disclosed in WO2009/099898 and WO2008/013775 may be used in some embodiments of the present invention, the disclosure of each of which is incorporated herein by reference in its entirety.

For example, in an embodiment, the display medium can be prepared by dissolving a polymer composite in a solvent such as toluene, filtering the solution, and drying the filtered solution in an oven by moderate heat such as at 50° C. under vacuum evaporation for several hours, thereby removing the solvent. The thus-obtained dried material can be homogenized mechanically at a relatively high temperature such as 130° C. several times. Small pieces of the homogenized material can then be melted on two electrodes such as two indium tin oxide (ITO)-coated glass electrodes, and assembled at a slightly higher temperature such as 150° C.

The photorefractive organic composite consists of several different components, such as a polymer matrix, non-liner optical chromophores, sensitizers, and plasticizers which can control composition glass transition temperature (Tg) as explained below. The polymer matrix can be synthesized from the corresponding monomers by radical polymerization technique, for example.

Photorefractivity is a phenomenon in which the refractive index of a material can be altered by changing the electric field within the material, such as by intense laser beam irradiation. The change of refractive index is achieved by a series of steps, including: (1) charge generation by laser irradiation, (2) charge transfer, resulting in separation of positive and negative charges, and (3) accumulation of charge (charge delocalization), (4) formation of a non-uniform internal electric field (space-charge field) as a result of charge delocalization, and (5) refractive index change induced by the non-uniform electric field.

An embodiment of this invention's photorefractive organic polymers comprises several different components; such as charge transfer components, nonlinear optics components, and photoelectron generation components, as mentioned before. Among them, major parts of components comprise charge transfer components and nonlinear optics components. Preferably, either or both charge transfer parts and nonlinear optics parts exist in a polymer matrix. Better yet, a polymer matrix, which has charge transfer parts in its side chain, shows better photorefractive performances. Usually, photoelectron generation parts can be given by various sensitizers, such as C60 and derivatives, 2,4,7-trinitro-9-fluorenone (TNF), quantum dots and carbon nanotubes.

An embodiment of the invention's organic polymers, which have charge transfer ability in the side chain, can be chosen from any organic materials that have charge transfer ability by a hopping conduction. However, having at least one tri-alkyl amino group containing polymers is desirable in order to achieve the highest photo refractivity performance. As the most preferred polymer example, a tri-alkyl amino group can be chosen from general formula group 1.

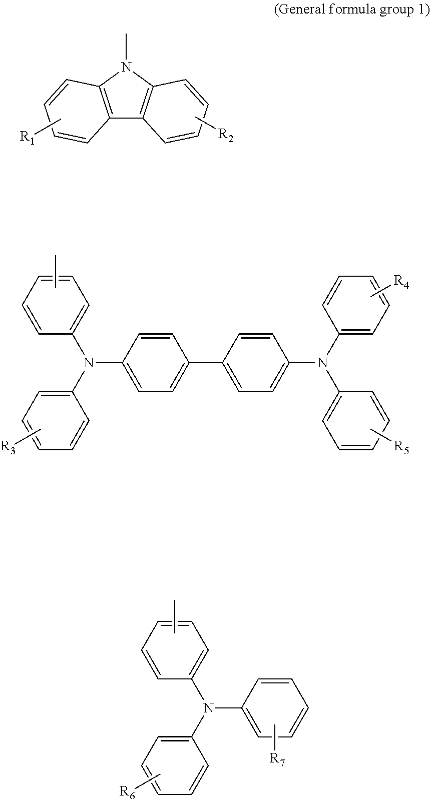

In the formula, R₁, R₂, R₃, R₄, R₅, R₆, and R₇ are each independently selected from the group consisting of a hydrogen atom, a linear alkyl group with up to 10 carbons, a branched alkyl group with up to 10 carbons, a linear alkyloxy group with up to 10 carbons, a branched alkyloxy group with up to 10 carbons, and an aromatic group with up to 10 carbons.

In principle, essentially any polymer backbone, including, but not limited to, vinyl polymers, polyurethane, epoxy polymers, polystyrene, polyether, polyester, polyamide, polyimide, polysiloxane, and polyacrylate could be used, with the appropriate side chains attached, to make the polymer matrices of the invention.

In contrast, our preferred materials, and particularly the (meth)acrylate-based polymers, have much better thermal and mechanical properties. That is, they provide better workability during processing by injection molding or extrusion, for example. This is particularly true when the polymers are prepared by radical polymerization. Preferred type of backbone units are those based on acrylates or styrene. These (meth)acrylate polymers are either homo- or copolymers which can be prepared from the corresponding (meth)acrylate monomers. Preferred types of monomers are those shown in general formula group 2.

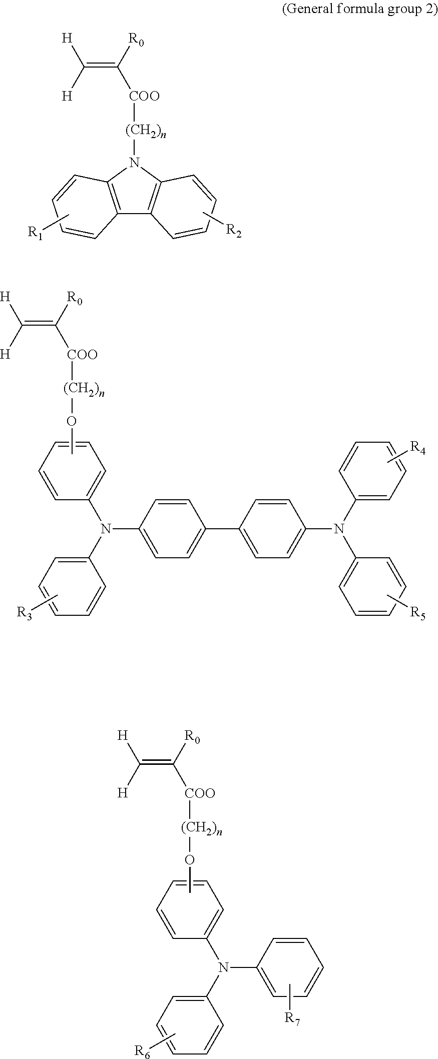

In the formula, R₁, R₂, R₃, R₄, R₅, R₆, and R₇ are each independently selected from the group consisting of a hydrogen atom, a linear alkyl group with up to 10 carbons, a branched alkyl group with up to 10 carbons, a linear alkyloxy group with up to 10 carbons, a branched alkyloxy group with up to 10 carbons, and an aromatic group with up to 10 carbons. R₀ represents a hydrogen atom, alkyl chain such as methyl group, etc. and n is an integer of 1 to 6.

Particular examples of monomers including a phenyl amine derivative group as the charge-transfer component are carbazolylpropyl(meth)acrylate monomer; 4-(N,N-diphenylamino)-phenylpropyl(meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers.

These (meth)acrylate monomers can be polymerized by using a conventional polymerization method. Any method, such as radical polymerization using azo-type initiator, living radical polymerization by using a transition metal, or a coordinate polymerization by using lanthanoid catalysis, can be used. However, the polymerization methods are not limited to those mentioned above.

In an embodiment of the present invention, the copolymer generally has a weight average molecular weight, Mw, of from about 3,000 to 500,000, preferably from about 5,000 to 100,000. The term “weight average molecular weight” as used herein means the value determined by the GPC (gel permeation chromatography) method in polystyrene standards, as is well known in the art.

Among organic compositions that show photo refractivity, a non-linear optical part can be obtained by a composition generally called a chromophore. This functional part can be dispersed in the polymer matrix. Or it can be also incorporated into a polymer side chain or polymer backbone by covalent bondage. Sometimes, to achieve better photo refractivity, the copolymer can be dispersed with a component that possesses non-linear optical properties through the polymer matrix, as is described in U.S. Pat. No. 5,064,264 to IBM, which is incorporated herein by reference. Suitable materials are known in the art and are well described in the literature, such as in D.S. Chemla & J. Zyss, “Nonlinear Optical Properties of Organic Molecules and Crystals” (Academic Press, 1987). The chemical compounds, shown in the following, can typically be used as non-limiting examples of chromophore additives:

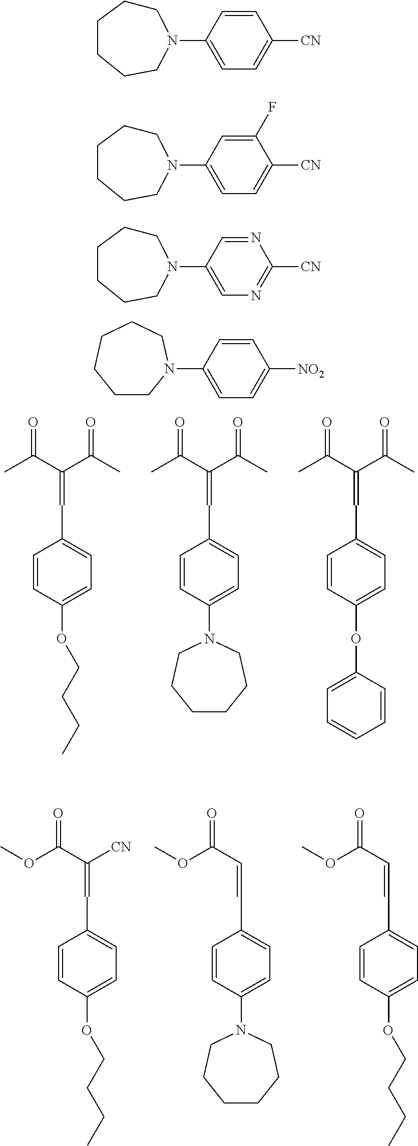

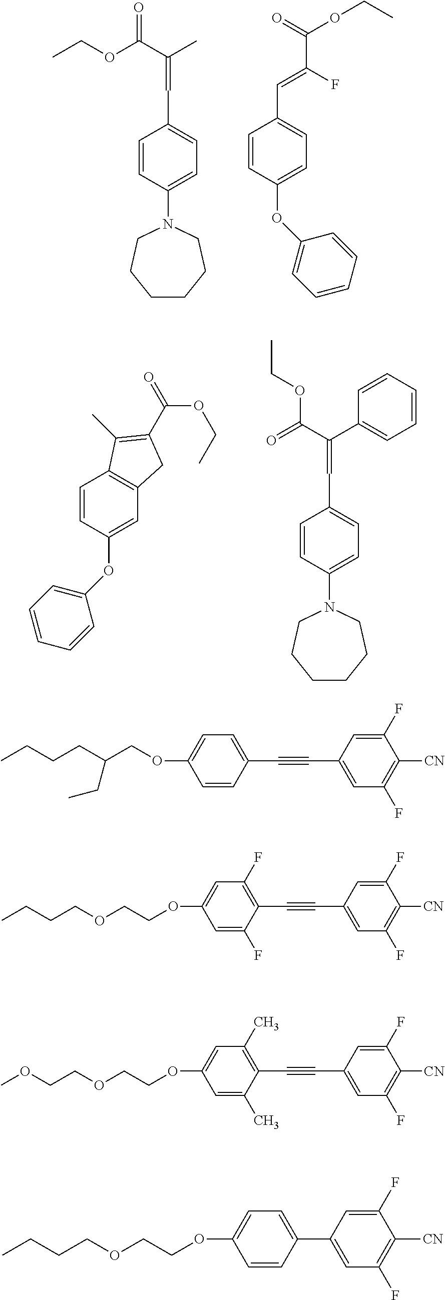

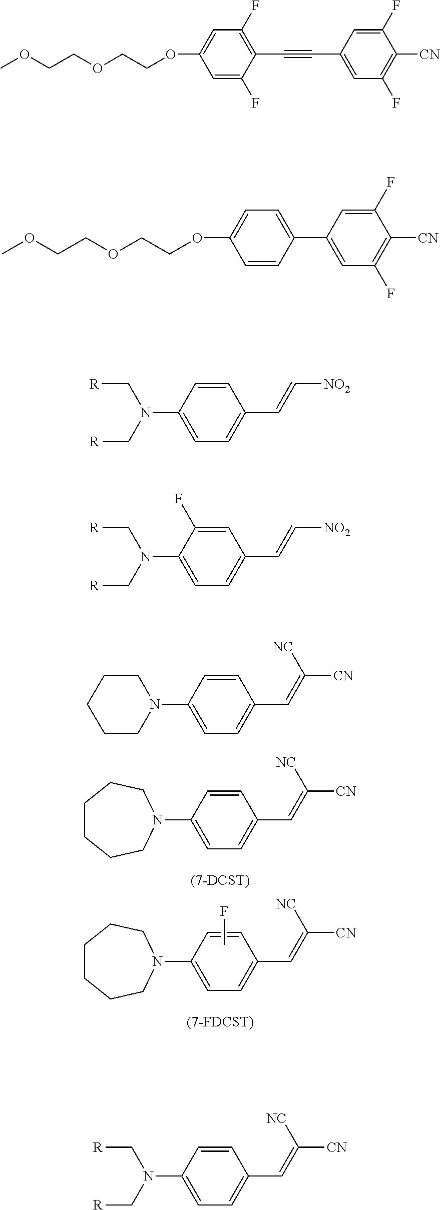

### (Examples of Electro Optics Effect Compound)

In the case of a copolymer, a monomer which has non-linear optical properties can be used as another monomer parts along with a trialkyl amino containing monomer which shows charge conductive properties. As a detailed example of monomers, the monomer that has the following functional parts in the side chain, shown in the following, can be used.

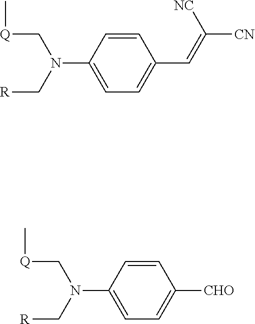

In the above, Q represents an alkylene group with or without a hetero atom, such as oxygen or sulfur, and preferably Q is an alkylene group represented by (CH₂)p; where p is between about 2 and 6; and R is a linear or branched alkyl group with up to 10 carbons; and preferably R is a alkyl group which is selected from methyl, ethyl, and propyl.

There are no restrictions as to the ratio of both charge transfer units and non-linear optics units. However, as a typical representative example, the ratio of a unit having charge transfer ability/a unit having non-linear optical ability is between about 4/1 and 1/4 by weight. Preferably, the ratio is between about 2/1 and 1/2 by weight. If this ratio is less than about 1/4, the charge transfer ability is weak, and the response time tends to be too slow to give good photo refractivity. On the other hand, if this ratio is more than about 2/1, the non-linear-optical ability is weak, and the diffraction efficiency tends to be too low to give good photo refractivity. These components can be added in the form of either a polymer side-chain or low molecular weight components.

Optionally, other components may be added to the polymer matrix to provide or improve the desired physical properties. Usually, for good photorefractive capability, it is preferable to add a photo sensitizer to serve as a charge generator. A wide choice of such photo sensitizers is known in the art. Typical, but non-limiting examples of photo sensitizers that may be used are 2,4,7-trinitro-9-fluorenone (TNF) and C60. The amount of photo sensitizer required is usually less than 3 wt %.

Also, it is preferred that the copolymer matrix has a relatively low glass-transition temperature, and is workable by conventional processing techniques. Optionally, a plasticizer may be added to the composition to reduce the glass transition temperature and/or facilitate workability. The type of plasticizer such as ethylcarbazole suitable for use in the invention is not restricted; many such materials will be familiar to those of skill in the art. Representative typical examples include phthalate derivatives, trialkyl amino containing low molecular weight additive, which are shown in general formula group 1, or oligomer-type compounds of the charge-transfer or non-linear-optical monomers may also be used to control the Tg of the composition.

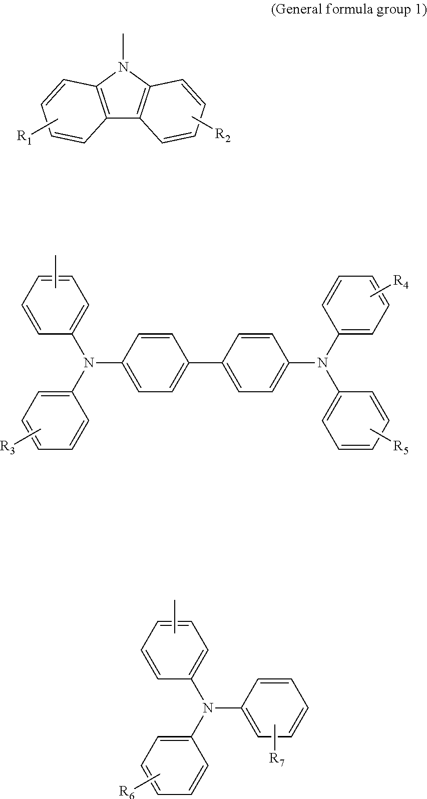

In the formula, R₁, R₂, R₃, R₄, R₅, R₆, and R₇ are each independently selected from the group consisting of a hydrogen atom, a linear alkyl group with up to 10 carbons, a branched alkyl group with up to 10 carbons, a linear alkyloxy group with up to 10 carbons, a branched alkyloxy group with up to 10 carbons, and an aromatic group with up to 10 carbons.

Most preferably, a compound selected from dioctyl phthalate, N-alkylcarbazole, or N-(acetoxypropylphenyl)-N,N′,N′-triphenyl-(1,1′-diphenyl)-4,4′-diamine, can be used.

Yet another method to adjust the Tg or improve film formation ability, for example, is to add another monomer, such as an acrylic or methacrylic acid alkyl ester, as a modifying co-monomer. Examples of modifying co-monomers are CH₂═CRo—COOR (wherein R₀ represents a hydrogen atom or methyl group, and R represents a C₂₋₁₄ alkyl group, such as butyl(meth)acrylate, ethyl(meth)acrylate, propylacrylate, 2-ethylhexyl(meth)acrylate and hexyl(meth)acrylate.

In some embodiments, a portion having charge transfer ability and a portion having non-linear optical ability account for no less than 90% (e.g., at least 95%) by weight of the organic composition, and other portions may include a sensitizer, a plasticizer, etc.

Usually applying bias voltage onto the composition is required to get better photo refractivity. A range of necessary bias voltage is between 0.01-100 V/μm.

In an embodiment this invention, photorefractive organic compositions are usually used in a form of bulk or film. There are no particular limitations to the style and shape, so the composition can be incorporated onto various kinds of substrates.

The three-dimensional holographic display medium of an embodiment is prepared by a composition comprising a photorefractive organic polymer having a tri-alkyl amino side-chain group, wherein the tri-alkyl amino side-chain group is selected from the group consisting of the structure shown in the above general formula group 1.

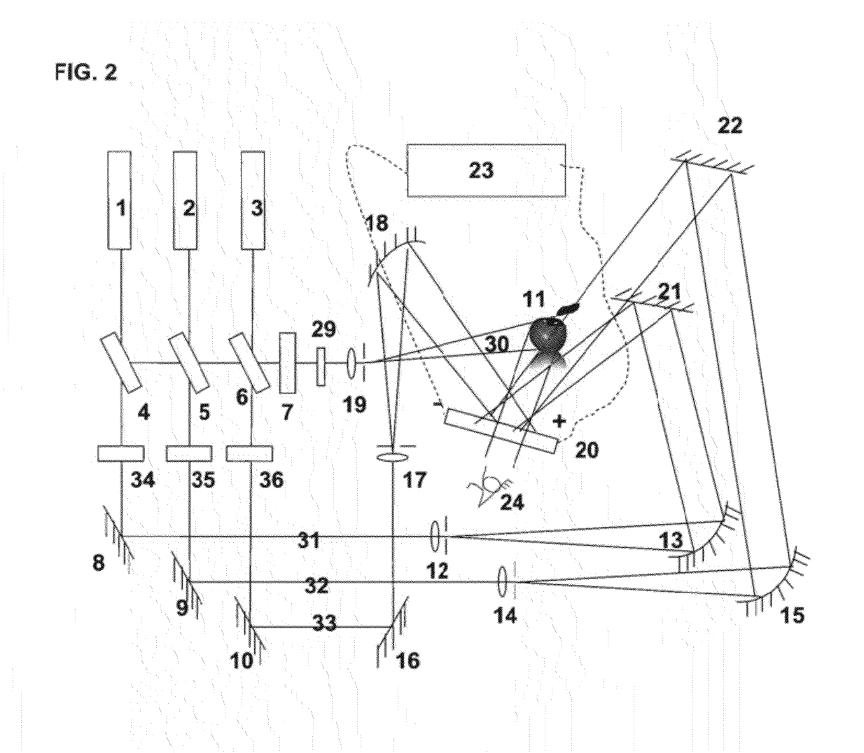

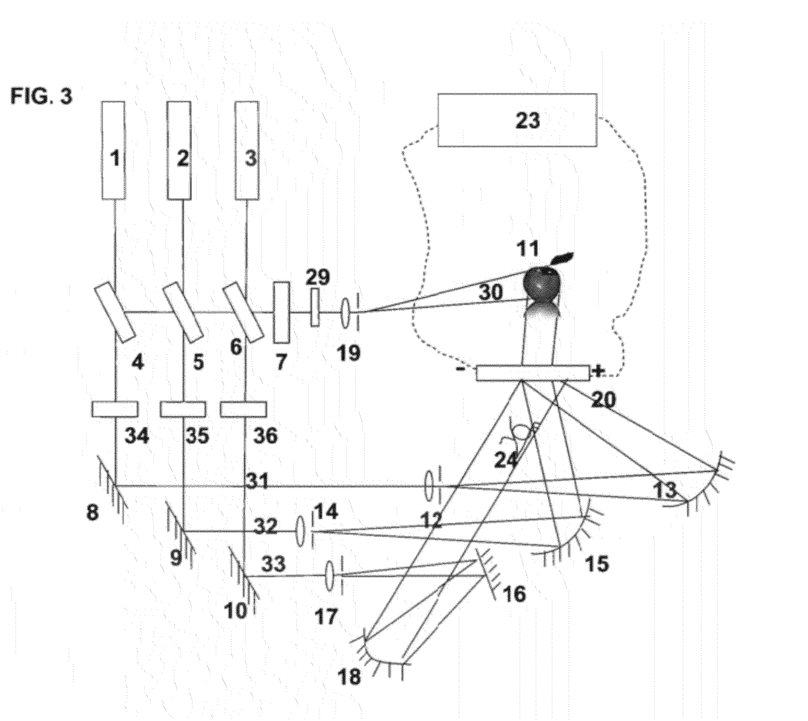

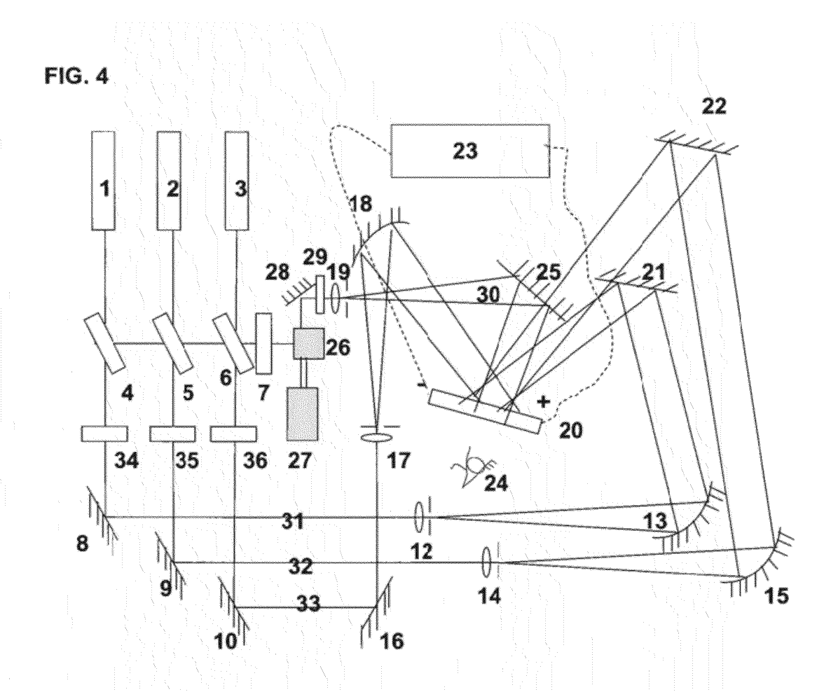

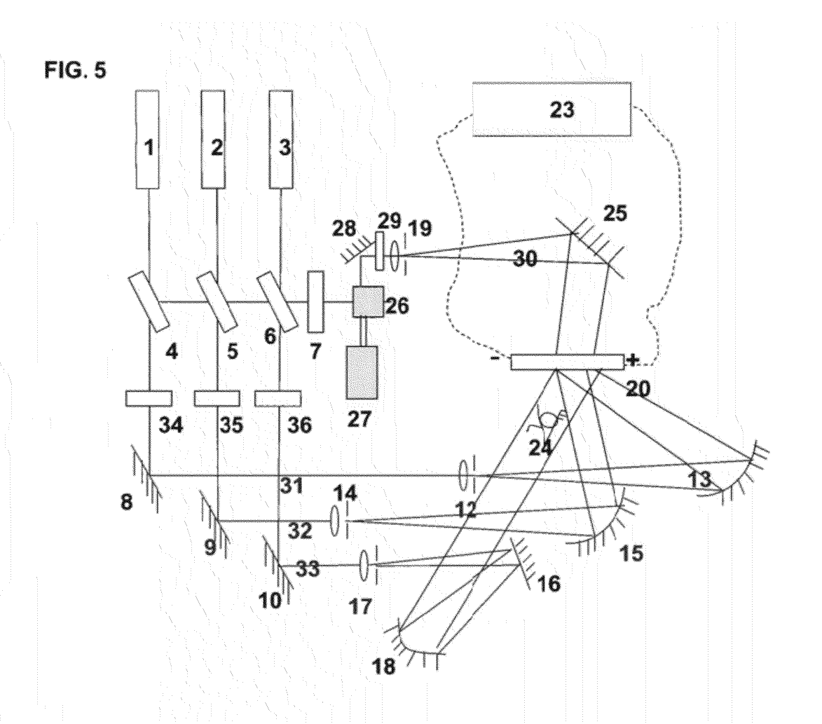

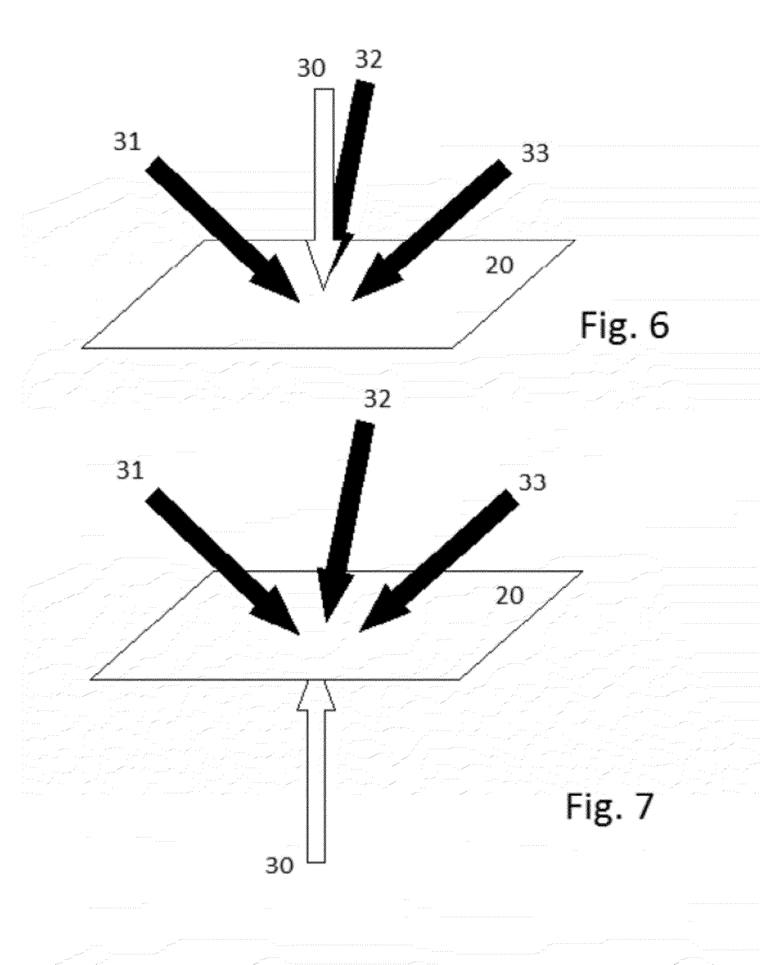

Typical examples of the three-dimensional holographic display device will be explained below using FIGS. 2, 3, 4, 5, 6 and 7 but are not intended to limit the scope or underlying principles in any way. FIG. 2 is a schematic illustration showing a first exemplary configuration of a holographic display device as an embodiment of the present invention. FIG. 3 is a schematic illustration showing a second exemplary configuration of a holographic display device as an embodiment of the present invention. FIG. 4 is a schematic illustration showing a third exemplary configuration of a holographic display device as an embodiment of the present invention. FIG. 5 is a schematic illustration showing a fourth exemplary configuration of a holographic display device as an embodiment of the present invention. FIG. 6 is a schematic illustration showing a laser beam arrangement for the first exemplary configuration and the third exemplary configuration of a holographic display device according to the disclosed embodiments of the present invention. FIG. 7 is a schematic illustration showing a laser beam arrangement for the second exemplary configuration and the fourth exemplary configuration of a holographic display device according to the disclosed embodiments of the present invention.

FIG. 2 shows the first exemplary schematic configuration of a holographic display device of an embodiment, which comprises a blue laser 1, a green laser 2, a red laser 3, a half minor 4, a dichroic half minor 5 reflecting a band in green, a dichroic half mirror 6 reflecting a band in red, a half-wave plate 7 for visible wavelength range, a minor 8, a minor 9, a mirror 10, a 3D object 11, a spatial filter 12, a collimating minor 13, a spatial filter 14, a collimating mirror 15, a mirror 16, a spatial filter 17, a collimating mirror 18, a spatial filter 19, a photorefractive medium 20, a minor 21, a mirror 22, a high voltage supplier 23, an observation position 24, a beam shutter 29, an object beam 30, a reference beam 31, a reference beam 32, a reference beam 33, a blue half-wave plate 34, a green half-wave plate 35 and a red half-wave plate 36. However, in this case, two-laser beam system (e.g., green and red laser beams) may be satisfactory enough for color 3D image application, since only two color lasers, such as green and red lasers, are good enough for color 3D images in some embodiments.

In this holographic display device of FIG. 2, the laser beams emitted by the laser 1, 2 and 3 are split through the half minor 4 and the dichroic half minors 5 and 6 that reflect green and red bands, respectively. Half of each laser beam is redirected and combined to produce a white laser beam 30 (an object beam). The polarization of the combined white light is tuned by the visible wavelength half-wave plate 7 to a desired polarization state. The object beam is then expanded through the spatial filter 19 and incident onto the 3D object 11.

The resultant reflected light is acting as the object beam that is incident onto the photorefractive medium 20. In some embodiments, the incident angle of this object beam is from −10 degrees to +10 degrees relative to the photorefractive medium normal. The passing-through blue reference beam 31 which has passed through the half mirror 4 is polarization tuned by the half-wave plate 34 and redirected by the mirror 8, then expanded and collimated through the spatial filter 12 and the collimating mirror 13 and redirected by the minor 21 to the photorefractive medium 20 from the same side of the photorefractive medium as that upon which the object beam is incident. In some embodiments, the incident beam angle of the redirected blue reference beam 31 is from −75 degrees to +75 degrees relative to the photorefractive medium normal, but should not be the symmetric incident angles to the object beam 30. The passing-through green reference beam 32 which has passed through the half mirror 5 is polarization tuned by the half-wave plate 35 and redirected by the mirror 9, then expanded and collimated through the spatial filter 14 and the collimating mirror 15 and redirected by the minor 22 to the photorefractive medium 20 from the same side of the photorefractive medium as that upon which the object beam is incident. In some embodiments, the incident beam angle of the redirected green reference beam 32 is from −75 degrees to +75 degrees to the photorefractive medium normal, but should not be the symmetric incident angles to the object beam 30.

The passing-through red reference beam 33 is polarization tuned by the half-wave plate 36 and redirected by the minors 10 and 16, then expanded and collimated through the spatial filter 17 and the collimating minor 18 and redirected to the photorefractive medium 20 from the same side of the photorefractive medium as that upon which the object beam is incident. The incident beam angle of the redirected red reference beam 33 is from −75 degree to +75 degree relative to the photorefractive medium normal, but should not be the symmetric incident angles to the object beam 30. All the three reference beams 31, 32 and 33 need to be arranged to be incident onto the photorefractive medium at different incident angles so as to avoid possible crosstalk between blue, green, and red color images, as shown in FIG. 6.

In this configuration of FIG. 2 at the time of recording three-dimensional images, the shutter 29 is at an open position. The object beam 30 and the reference beams 31-33 illuminate the photorefractive medium 20 at the same time, while applying a high bias voltage to the photorefractive medium 20 using the voltage supplier 23. The intensity ratio of the object beam to the reference beams is adjusted to obtain the best recording performance. After the recording is done, the shutter 29 is turned off. The reconstructed 3D image of the real object can then be viewed from the observation position 24 by illumination of the reference beam 31, 32 and 33. The virtual 3D image will appear right at the position of the original 3D object as if the original 3D object is still there. The photorefractive medium has excellent rewritable properties. That is, the 3D image can be erased by illumination of uniform three-color laser beams on the photorefractive medium while applying high bias thereto. After the image is completely erased, a second image of the same sample can be written by following the same procedures as those described above. This writing/reading-erasing-rewriting/reading process can be repeated over 10,000 times (at least 3,000 times) without substantial image degradation or performance decay.

FIG. 3 shows the second exemplary schematic configuration of a holographic display device of an embodiment, which differs from the configuration of FIG. 2 in that a reflection 3D hologram is recorded and reconstructed.

In this holographic display device of FIG. 3, the laser beams emitted by the laser 1, 2 and 3 are split through the half minor 4 and the dichroic half minors 5 and 6 that reflect green and red bands, respectively. Half of each laser beam is redirected and combined to produce a white laser beam 30 (an object beam). The polarization of the combined white light is tuned by the visible wavelength half-wave plate 7 to a desired polarization state. The object beam is then expanded through the spatial filter 19 and incident onto the 3D object 11. The resultant reflected light is acting as the object beam that is incident onto the photorefractive medium 20. In some embodiments, the incident angle of this object beam is from −10 degrees to +10 degrees relative to the photorefractive medium normal. The passing-through blue reference beam 31 which has passed through the half mirror 4 is polarization tuned by the half-wave plate 34 and redirected by the mirror 8, then expanded and collimated through the spatial filter 12 and the collimating minor 13 and redirected to the photorefractive medium 20 from the opposite side of the photorefractive medium to that upon which the object beam is incident. The incident beam angle of the redirected blue reference beam 31 is from −75 degrees to +75 degrees relative to the photorefractive medium normal. The passing-through green reference beam 32 which has passed through the half-minor 5 is polarization tuned by the half-wave plate 35 and redirected by the minor 9, then expanded and collimated through the spatial filter 14 and the collimating mirror 15 and redirected to the photorefractive medium 20 from the opposite side of the photorefractive medium to that upon which the object beam is incident. The incident beam angle of the redirected green reference beam 32 is from −75 degrees to +75 degrees relative to the photorefractive medium normal. The passing-through red reference beam 33 which has passed through the half-minor 6 is polarization tuned by the half-wave plate 36 and redirected by the mirror 10, then expanded and collimated through the spatial filter 17 and the collimating mirror 18 and redirected to the photorefractive medium 20 from the opposite side of the photorefractive medium to that upon which the object beam is incident. The incident beam angle of the redirected red reference beam 33 is from −75 degrees to +75 degrees relative to the photorefractive medium normal. All the three reference beams 31, 32 and 33 need to be arranged to be incident onto the photorefractive medium at different incident angles so as to avoid possible crosstalk between blue, green, and red color images, as shown in FIG. 7.$

In this configuration of FIG. 3 at the time of recording three-dimensional images, the shutter 29 is at an open position. The object beam and the reference beams illuminate the photorefractive medium 20 at the same time, while applying a high bias voltage to the photorefractive medium 20 using the voltage supplier 23. The intensity ratio of the object beam to the reference beams is adjusted to obtain the best recording performance. After the recording is done, the shutter 29 is turned off. The reconstructed 3D image of the real object can then be viewed from the observation position 24 by illumination of the reference beams 31, 32 and 33. The virtual 3D image will appear right at the position of the original 3D object as if the original 3D object is still there. The photorefractive medium has excellent rewritable properties. That is, the 3D image can be erased by illumination of uniform three-color laser beams on the photorefractive medium while applying high bias thereto. After the image is completely erased, a second image of the same sample can be written by following the same procedures as those described above. This writing/reading-erasing-rewriting/reading process can be repeated over 10,000 times (at least 3,000 times) without substantial image degradation or performance decay.

Other examples of the three-dimensional holographic display device will be explained below with reference to FIGS. 4 and 5, but are not intended to limit the scope or underlying principles in any way.

FIG. 4 shows the third exemplary schematic configuration of a holographic display device of an embodiment, which comprises a blue laser 1, a green laser 2, a red laser 3, a half minor 4, a dichroic half minor 5 reflecting a band in green, a dichroic half mirror 6 reflecting a band in red, a half-wave plate 7 for visible wavelength range, a minor 8, a minor 9, a mirror 10, a 3D object 11, a spatial filter 12, a collimating minor 13, a spatial filter 14, a collimating mirror 15, a mirror 16, a spatial filter 17, a collimating mirror 18, a spatial filter 19, a photorefractive medium 20, a minor 21, a mirror 22, a high voltage supplier 23, an observation position 24, a moveable minor 25, a spatial light modulator 26, a spatial light modulator control device 27, a mirror 28, a beam shutter 29, an object beam 30, a reference beam 31, a reference beam 32, a reference beam 33, a blue half-wave plate 34, a green half-wave plate 35 and a red half-wave plate 36. In this case, the two laser beam system is satisfactory enough for application, since only two color lasers, such as green and red lasers, are good enough for color 3D images.

In this holographic display device of FIG. 4, the laser beams emitted by the laser 1, 2 and 3 are split through the half minor 4 and the dichroic half minors 5 and 6 that reflect green and red bands, respectively. Half of each laser beam is redirected and combined to produce a white laser beam 30 (an object beam). The polarization of the combined white light is tuned by the visible wavelength half-wave plate 7 to a desired polarization state. The holographic object light 30 is obtained by entering the incident light for holographic object light into the spatial light modulator 26 on which a holographic object light generation pattern is generated under the control of the spatial light modulator control device 27. As another device for providing light image patterns, an LCD device or a Digital Micromirror device can also be used instead of the spatial light modulator 26. The output image beam that has been outputted from the spatial light modulator 26 is redirected by the mirror 28 and then expanded through the spatial filter 19 and incident onto the minor 25. The resultant reflected light is acting as the object beam that is incident onto the photorefractive medium 20. In some embodiments, the incident angle of this object beam is from −10 degrees to +10 degrees relative to the photorefractive medium normal. The passing-through blue reference beam 31 which has passed through the half mirror 4 is polarization tuned by the half-wave plate 34 and redirected by the minor 8, then expanded and collimated through the spatial filter 12 and the collimating mirror 13 and redirected by the mirror 21 to the photorefractive medium 20 from the same side of the photorefractive medium 20 as that upon which the object beam is incident. In some embodiments, the incident beam angle of the redirected blue reference beam 31 is from −75 degrees to +75 degrees relative to the photorefractive medium normal, but should not be the symmetric incident angles to the object beam 30. The passing-through green reference beam 32 which has passed through the half minor 5 is polarization tuned by the half-wave plate 35 and redirected by the mirror 9, then expanded and collimated through the spatial filter 14 and the collimating mirror 15 and redirected by the minor 22 to the photorefractive medium 20 from the same side of the photorefractive medium 20 as that upon which the object beam is incident. In some embodiments, the incident beam angle of the redirected green reference beam 32 is from −75 degrees to +75 degrees relative to the photorefractive medium normal, but should not be the symmetric incident angles to the object beam 30.

The passing-through red reference beam 33 which has passed through the half mirror 6 is polarization tuned by the half-wave plate 36 and redirected by the mirrors 10 and 16, then expanded and collimated through the spatial filter 17 and the collimating minor 18 and redirected to the photorefractive medium 20 from the same side of the photorefractive medium 20 as that upon which the object beam is incident. In some embodiments, the incident beam angle of the redirected red reference beam 33 is from −75 degrees to +75 degrees relative to the photorefractive medium normal, but should not be the symmetric incident angles to the object beam 30. All the three reference beams 31, 32 and 33 need to be arranged to be incident onto the photorefractive medium at different incident angles so as to avoid possible crosstalk between blue, green, and red color images, as shown in FIG. 6.

In this configuration of FIG. 4, at the time of recording three-dimensional images, the shutter 29 is at an open position, and the movable mirror 25 is moved and fixed to a first specific angle. Then, one of a plurality of holographic object light generation patterns is generated at the spatial light modulator 26, and the incident light for holographic object beam 30 and the reference beams 31, 32 and 33 are entered. By this series of operations, a first three-dimensional image is recorded in the photorefractive medium 20.

The movable minor 25 is then moved and fixed to another specific angle, the holographic object light generation pattern to be displayed at the spatial light modulator 26 is switched, and the incident light for holographic object beam 30 and the reference beams 31, 32 and 33 are entered, so as to record a second three-dimensional image in the photorefractive medium 20. By repeating the similar operations within a range of movable angles of the movable minor 25, a plurality of three-dimensional images are multiply recorded in the photorefractive medium 20.

At the time of reproducing three-dimensional images, the incident light for holographic object beam 30 is blocked by shutting off the shutter 29, and only the reference beams 31, 32 and 33 are irradiated onto the photorefractive medium 20 so that the multiply recorded three-dimensional images are reproduced collectively. The virtual 3D image will appear as hologram images. As in the other configurations, the photorefractive medium has excellent rewritable properties. That is, the 3D image can be erased by illumination of uniform three-color laser beams on the photorefractive medium while applying high bias thereto. After the image is completely erased, a second image of the same sample can be written by following the same procedures as those described above. This writing/reading-erasing-rewriting/reading process can be repeated over 10,000 times (at least 3,000 times) without substantial image degradation or performance decay.

FIG. 5 shows the fourth exemplary schematic configuration of a holographic display device of an embodiment of the present invention, which differs from the configuration of FIG. 4 in that a reflection 3D hologram is recorded and reconstructed.

In this holographic display device of FIG. 5, the laser beams emitted by the laser 1, 2 and 3 are split through the half minor 4 and the dichroic half minors 5 and 6 that reflect green and red bands, respectively. Half of each laser beam is redirected and combined to a white laser beam 30 (an object beam). The polarization of the combined white light is tuned by the visible wavelength half-wave plate 7 to a desired polarization state. The holographic object light 30 is obtained by entering the incident light for holographic object light into the spatial light modulator 26 on which the holographic object light generation pattern is generated under the control of the spatial light modulator control device 27. As another device for providing light image patterns, an LCD device or a Digital Micromirror device can also be used instead of the spatial light modulator 26. The output image beam that has been outputted from the spatial light modulator 26 is redirected by the mirror 28 and then expanded through the spatial filter 19 and incident onto the minor 25. The resultant reflected light is acting as the object beam that is incident to the photorefractive medium 20. In some embodiments, the incident angle of this object beam is from −10 degrees to +10 degrees relative to the photorefractive medium normal. The passing-through blue reference beam 31 which has passed through the half mirror 4 is polarization tuned by the half-wave plate 34 and redirected by the minor 8, then expanded and collimated through the spatial filter 12 and the collimating mirror 13 and redirected to the photorefractive medium 20 from the opposite side of the photorefractive medium 20 to that upon which the object beam is incident. In some embodiments, the incident beam angle of the redirected blue reference beam 31 is from −75 degrees to +75 degrees relative to the photorefractive medium normal. The passing-through green reference beam 32 which has passed through the half mirror 5 is polarization tuned by the half-wave plate 35 and redirected by the mirror 9, then expanded and collimated through the spatial filter 14 and the collimating minor 15 and redirected to the photorefractive medium from the opposite side of the photorefractive medium 20 to that upon which the object beam is incident. In some embodiments, the incident beam angle of the redirected green reference beam 32 is from −75 degrees to +75 degrees relative to the photorefractive medium normal. The passing-through red reference beam 33 which has passed through the half mirror 36 is polarization tuned by the half-wave plate 36 and redirected by the minor 10, then expanded through the spatial filter 17, redirected by the minor 16, collimated by the collimating mirror 18, and redirected to the photorefractive medium 20 from the opposite side of the photorefractive medium 20 to that upon which the object beam is incident. In some embodiments, the incident beam angle of the redirected red reference beam 33 is from −75 degrees to +75 degrees relative to the photorefractive medium normal. All the three reference beams 31, 32 and 33 need to be arranged to be incident onto the photorefractive medium at different incident angles to avoid possible crosstalk between blue, green, and red color images, as shown in FIG. 7.

In this configuration of FIG. 5, at the time of recording three-dimensional images, the shutter 29 is at an open position, and the movable mirror 25 is moved and fixed to a first specific angle. Then, one of a plurality of holographic object light generation patterns is generated at the spatial light modulator 26, and the incident light for holographic object beam 30 and the reference beams 31, 32 and 33 are entered. By this series of operations, a first three-dimensional image is recorded in the photorefractive medium 20.

The movable minor 25 is then moved and fixed to another specific angle, the holographic object light generation pattern to be displayed at the spatial light modulator 26 is switched, and the incident light for holographic object beam 30 and the reference beams 31, 32 and 33 are entered, so as to record a second three-dimensional image in the photorefractive medium 20. By repeating the similar operations within a range of movable angles of the movable minor 25, a plurality of three-dimensional images are multiply recorded in the photorefractive medium 20.

At the time of reproducing three-dimensional images, the incident light for holographic object beam 30 is blocked by shutting off the shutter 29, and only the reference beams 31, 32 and 33 are irradiated onto the photorefractive medium 20 so that the multiply recorded three-dimensional images are reproduced collectively. The virtual 3D image will appear as hologram images. As in the other configurations, the photorefractive medium has excellent rewritable properties. That is, the 3D image can be erased by illumination of uniform three-color laser beams on the photorefractive medium while applying high bias thereto. After the image is completely erased, a second image of the same sample can be written by following the same procedures as those described above. This writing/reading-erasing-rewriting/reading process can be repeated over 10,000 times (at least 3,000 times) without substantial image degradation or performance decay.

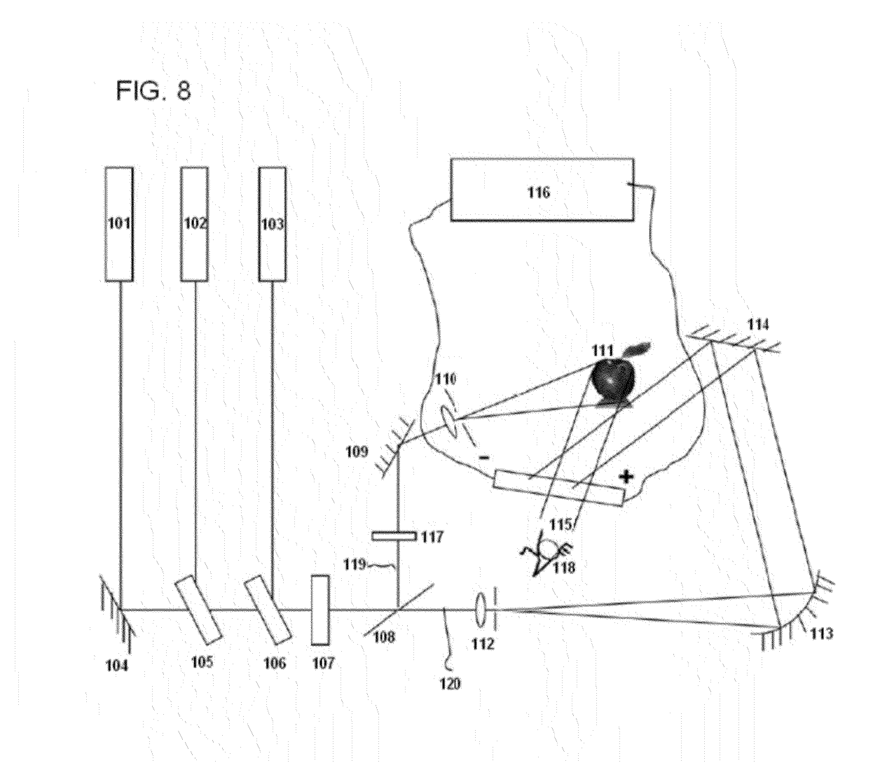

In some embodiments, the holographic display device can have simplified configurations as illustrated in FIGS. 8-11 where a single reference laser beam produced by combining multiple laser beams is used.

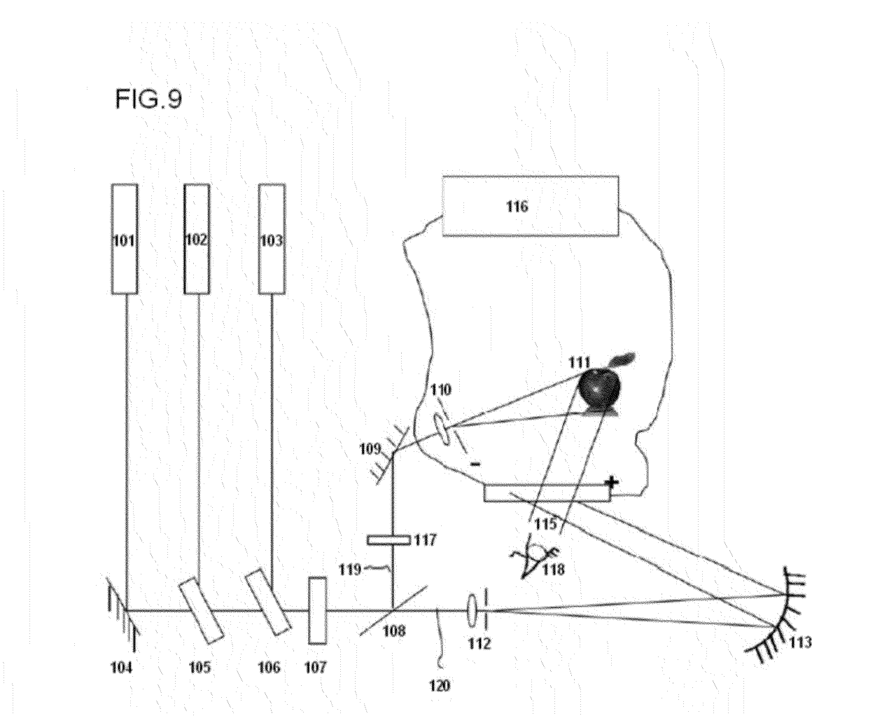

Typical examples of such a three-dimensional holographic display device will be explained below using FIGS. 8 and 9, but are not intended to limit the scope or underlying principles in any way. FIG. 8 is a schematic illustration showing a fifth exemplary configuration of a holographic display device as an embodiment of the present invention. FIG. 9 is a schematic illustration showing a sixth exemplary configuration of a holographic display device as an embodiment of the present invention. The laser beam arrangements shown in FIGS. 8 and 9 correspond to those shown in FIGS. 6 and 7, respectively.

FIG. 8 shows the fifth exemplary schematic configuration of the holographic display device, which comprises a blue laser 101, a green laser 102, a red laser 103, a mirror 104, a dichroic filter 105 reflecting a band in green, a dichroic filter 106 reflecting a band in red, a half-wave plate 107 for visible wavelength range, a visible wavelength range beam splitter 108, a mirror 109, a spatial filter 110, a 3D object 111, a spatial filter 112, a collimating mirror 113, a mirror 114, a photorefractive medium 115, a high voltage supplier 116, a beam shutter 117, an observation position 118, an object beam 119 and a reference beam 120.

In this holographic display device of FIG. 8, the laser beams emitted by the lasers 101, 102 and 103 are redirected and combined through the minor 104, and the dichroic filters 105 and 106 that reflect green and red bands, respectively. The polarization of the combined white light is tuned by the visible wavelength half-wave plate 107 to a desired polarization state. The white beam is divided to an object beam 119 and a reference beam 120 at the beam splitter 108. The object beam is then redirected through the mirror 109 and is expanded through the spatial filter 110 and incident onto the 3D object 111. The resultant reflected light is acting as the object beam that is incident onto the photorefractive medium 115. In some embodiments, the incident angle of this object beam is from −75 degrees to +75 degrees relative to the photorefractive medium normal, but should not be the symmetric incident angles with regard to the reference beam 120. The reference beam 120 is expanded and collimated through the spatial filter 112 and the collimating mirror 113 and redirected to the photorefractive medium 115 from the same side of the photorefractive medium as that upon which the object beam is incident. In some embodiments, the incident beam angle of the redirected reference beam is from −75 degrees to +75 degrees relative to the photorefractive medium normal, but should not be the symmetric incident angles with respect to the object beam 119.

In this configuration of FIG. 8 at the time of recording three-dimensional images, the shutter 117 is set at an open position. The object beam and the reference beam illuminate the photorefractive medium at the same time, while applying a high bias voltage to the photorefractive medium 115 at the same time. The intensity ratio between the object beam and the reference beam is adjusted to obtain the best recording performance. After the recording is done, the shutter 117 is turned off. The reconstructed 3D image of the real object can then be viewed from the observation position 118 by illumination of the reference beam 120. The virtual 3D image will appear right at the position of the original 3D object as if the original 3D object is still there. As in the other configurations, the photorefeactive medium has excellent rewritable properties. That is, the 3D image can be erased by illumination of uniform three-color laser beams on the photorefractive medium while applying high bias thereto. After the image is completely erased, a second image of the same sample can be written by following the same procedures as those described above. This writing/reading-erasing-rewriting/reading process can be repeated over 10,000 times (at least 3,000 times) without substantial image degradation or performance decay.

FIG. 9 shows the sixth exemplary schematic configuration of the holographic display device, which differs from the configuration of FIG. 8 in that a reflection 3D hologram is recorded and reconstructed.

In this holographic display device of FIG. 9, the laser beams emitted by the lasers 101, 102 and 103 are redirected and combined through the mirror 104 and the dichroic filters 105 and 106 that reflect green and red bands, respectively. The polarization of the combined white light is tuned by the visible wavelength half-wave plate 107 to a desired polarization state. The white beam is divided to the object beam 119 and the reference beam 120 at the beam splitter 108. The object beam is then redirected through the mirror 109 and is expanded through the spatial filter 110 and incident onto the 3D object 111. The resultant reflected light is acting as the object beam that is incident onto the photorefractive medium 115. In some embodiments, the incident angle of this object beam is from 0 degree to +75 degrees relative to the photorefractive medium normal. The reference beam 120 is expanded and collimated through the spatial filter 112 and the collimating mirror 113 and redirected to the photorefractive medium 115 from the opposite side of the photorefractive medium 115 to that upon which the object beam is incident. In some embodiments, the incident beam angle of the redirected reference beam is from 0 degree to +70 degrees relative to the photorefractive medium normal.

In this configuration of FIG. 9, at the time of recording three-dimensional images, the shutter 117 is set at an open position. The object beam and the reference beam illuminate the photorefractive medium 115 at the same time, while applying a high bias voltage to the photorefractive medium at the same time. The intensity ratio between the object beam and the reference beam is adjusted to obtain the best recording performance. After the recording is done, the shutter 117 is turned off. The reconstructed 3D image of the real object can then be viewed from the observation position 118 by illumination of the reference beam 120. The virtual 3D image will appear right at the position of the original 3D object. As in the other configurations, the photorefractive medium has excellent rewritable properties. That is, the 3D image can be erased by illumination of uniform three-color laser beams on the photorefractive medium while applying high bias thereto. After the image is completely erased, a second image of the same sample can be written by following the same procedures as those described above. This writing/reading-erasing-rewriting/reading process can be repeated over 10,000 times (at least 3,000 times) without substantial image degradation or performance decay.

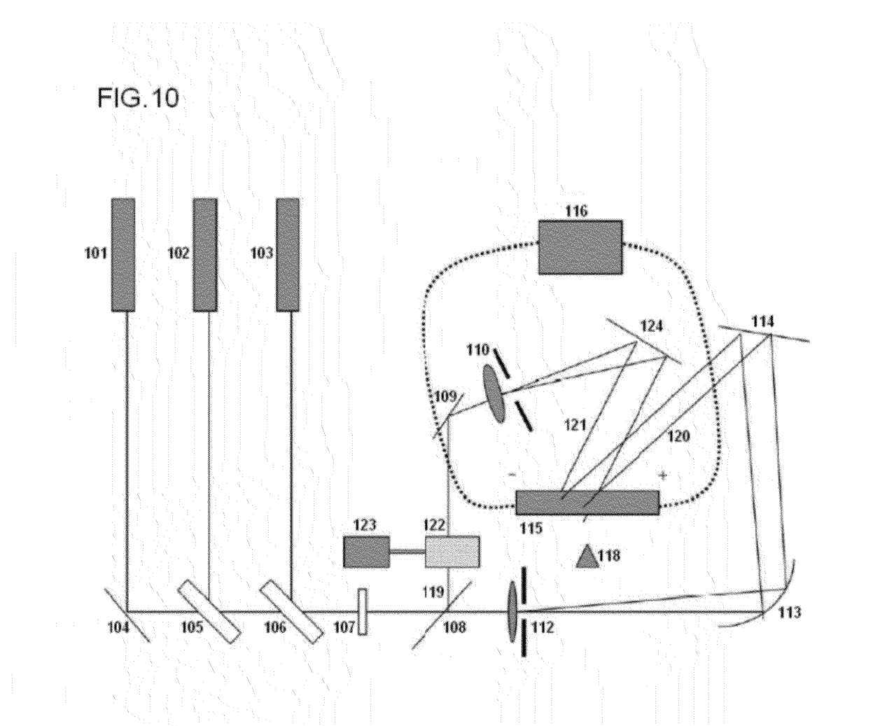

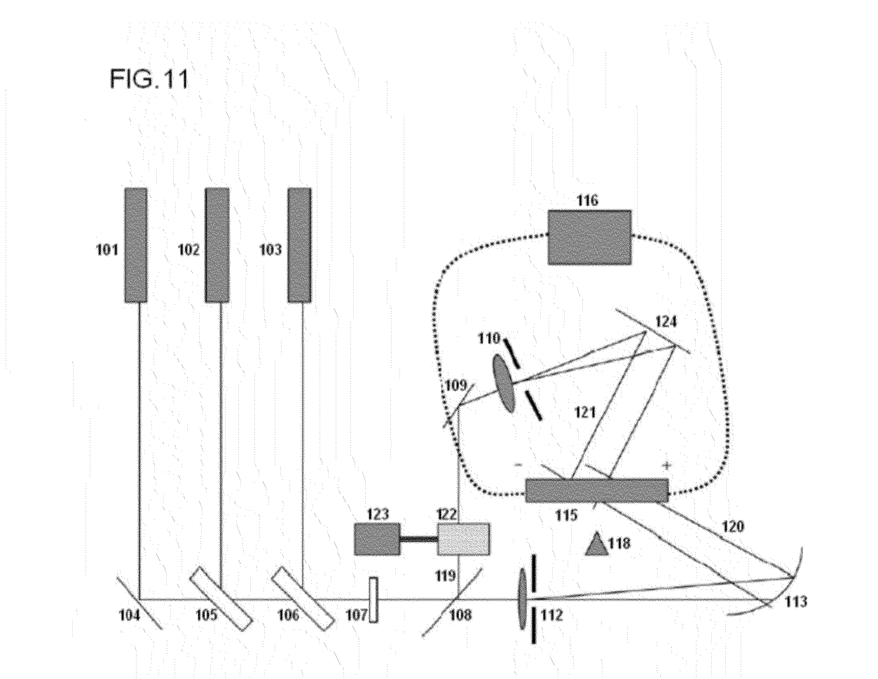

Other examples of the three-dimensional holographic display device will be explained below using FIGS. 10 and 11, but are not intended to limit the scope or underlying principles in any way. FIG. 10 is a schematic illustration showing the seventh exemplary configuration of a holographic display device as embodiment of the present invention. FIG. 11 is a schematic illustration showing the eighth exemplary configuration of a holographic display device as an embodiment of the present invention. The laser beam arrangements shown in FIGS. 10 and 11 correspond to those shown in FIGS. 6 and 7, respectively.

FIG. 10 shows the seventh exemplary schematic configuration of the holographic display device, which comprises a blue laser 101, a green laser 102, a red laser 103, a mirror 104, a dichroic filter 105 reflecting band in the green, a dichroic filter 106 reflecting band in the red, a half-wave plate 107 for visible wavelength range, a visible wavelength range beam splitter 108, a mirror 109, a spatial filter 110, a minor 124, a spatial filter 112, a collimating minor 113, a mirror 114, a photorefractive medium 115, a high voltage supplier 116, a spatial light modulator 122, a spatial light modulator control device 123, an observation position 118, an incident light for holographic object light 121, an object beam 119, and a reference beam 120.

In this holographic display device of FIG. 10, the laser beams emitted by the lasers 101, 102 and 103 are redirected through the minor 104 and the combined through dichroic filters 105 and 106 that reflect green and red bands, respectively. The polarization of the combined white light is tuned by the visible wavelength half-wave plate 107 to a desired polarization state. The beams are divided to the object beam 119 and the reference beam 120 at the beam splitter 108. The holographic object light 121 is obtained by entering the incident light for holographic object light into the spatial light modulator 122 on which the holographic object light generation pattern is generated under the control of the spatial light modulator control device 123. As another device for providing light image patterns, an LCD device can also be used instead of the spatial light modulator 122. The output image beam that has been outputted from the spatial light modulator 122 is then redirected through the minor 109 and is expanded through spatial filter 110 and incident onto the minor 124. The resultant reflected light is acting as the object beam that is incident onto the photorefractive medium 115. In some embodiments, the incident angle of this object beam is from −75 degrees to +75 degrees relative to the photorefractive medium normal, but should not be the symmetric incident angles with respect to the reference beam 120. Also, the incident angle of the object beam for holographic object light 121 with respect to the spatial light modulator 122 can be changed by moving the movable minor 124. The reference beam 120 is expanded and collimated through the spatial filter 112 and the collimating mirror 113 and redirected to the photorefractive medium 115 from the same side of the photorefractive medium as that upon which the object beam is incident. In some embodiments, the incident angle of the reference beam is from −75 degrees to +75 degrees relative to the photorefractive medium normal, but should not be the symmetric incident angles with respect to the holographic object light 121.

In this configuration of FIG. 10, at the time of recording three-dimensional images, the movable minor 124 is moved and fixed to a first specific angle. Then, one of a plurality of holographic object light generation patterns is generated at the spatial light modulator 122, and the incident light for holographic object beam 121 and the reference beam 120 are entered. By this series of operations, a first three-dimensional image is recorded in the photorefractive medium 115.

The movable mirror 124 is then moved and fixed to another specific angle, the holographic object light generation pattern to be displayed at the spatial light modulator 122 is switched, and the incident light for holographic object beam 121 and the reference beam 120 are entered, so as to record a second three-dimensional image in the photorefractive medium 115. By repeating the similar operations within a range of movable angles of the movable mirror 124, a plurality of three-dimensional images are multiply recorded in the photorefractive medium 115.

At the time of reproducing three-dimensional images, the incident light for holographic object beam 121 is blocked, and only the reference beam 120 is irradiated onto the photorefractive medium 115 so that the multiply recorded three-dimensional images are reproduced collectively. The virtual 3D image will appear as hologram images. As in the other configurations, the photorefractive medium is rewritable and has excellent rewritable properties.

FIG. 11 shows the eighth exemplary schematic configuration of the holographic display device, which differs from the configuration of FIG. 10 in that a reflection 3D hologram is recorded and reconstructed.

In this holographic display device of FIG. 11, the laser beams emitted by the lasers 101, 102 and 103 are redirected and combined through the mirror 104 and the dichroic filters 105 and 106 that reflect green and red bands, respectively. The polarization of the light is tuned by the visible wavelength half-wave plate 107 to a desired polarization state. The beams are divided to an object beam 119 and a reference beam 120 at the beam splitter 108. The holographic object light 121 is obtained by entering the incident light for holographic object beam into the spatial light modulator 122 on which the holographic object light generation pattern is generated under the control of the spatial light modulator control device 123. As another device, an LCD device can also be used instead of the spatial light modulator device. The object beam is then redirected through the mirror 109 and is expanded through the spatial filter 110 and incident onto the minor 124. The resultant reflected light is acting as the object beam that is incident to the photorefractive medium 115. In some embodiments, the incident angle of this object beam is from 0 degree to +75 degrees relative to the photorefractive medium normal. The reference beam 120 is expanded and collimated through the spatial filter 112 and the collimating minor 113 and redirected to the photorefractive medium 115 from the opposite side of the photorefractive medium to that upon which the object beam is incident. In some embodiments, the incident angle of the redirected reference beam is from 0 degree to +70 degrees relative to the photorefractive medium normal.

In this configuration of FIG. 11, at the time of recording three-dimensional images, the movable minor 124 is moved and fixed to a first specific angle. Then, one of a plurality of holographic object light generation patterns is generated at the spatial light modulator 122, and the incident light for holographic object beam 121 and the reference beam 120 are entered. By this series of operations, a first three-dimensional image is recorded in the photorefractive medium 115.

The movable mirror 124 is then moved and fixed to another specific angle, the holographic object light generation pattern to be displayed at the spatial light modulator 122 is switched, and the incident light for holographic object light 121 and the reference light 120 are entered, so as to record a second three-dimensional image in the photorefractive medium 115. By repeating the similar operations within a range of movable angles of the movable mirror 124, a plurality of three-dimensional images are multiply recorded in the photorefractive medium 115.

At the time of reproducing three-dimensional images, the incident light for holographic object beam 121 is blocked, and only the reference beam 120 is irradiated onto the photorefractive medium 115 so that the multiply recorded three-dimensional images are reproduced collectively. The virtual 3D image will appear as hologram images. As in the other configurations, the photorefractive medium is rewritable and has excellent rewritable properties.

In the following section, typical composition examples used for an embodiment of this invention's organic photorefractive composition will be shown, but are not intended to limit the scope or underlying principles in any way.

In the present disclosure where conditions and/or structures are not specified, a skilled artisan in the art can readily provide such conditions and/or structures, in view of the present disclosure, as a matter of routine experimentation.

### Preparation Example 1

For the photorefractive organic composition, the composition was prepared from the following components.

<Composition>

Acrylate copolymer prepared from N-[(meth)acroyloxypropylphenyl]-N,N′,N′-triphenyl-(1,1′-biphenyl)-4,4′-diamine (charge transfer component) and the following acrylate (non-linear optical component) with a weight ratio of 10/1 (50 weight parts)

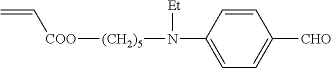

1-(4-nitrophenyl)azepane (30 weight parts; non-linear optical component)

Ethylcarbazole (20 weight parts; plasticizer)

PCBM[C60] (0.3 weight parts; photo sensitizer)

The copolymer was synthesized from the above monomers by radical polymerization technique. In the above, the copolymer has a ratio of a unit having charge transfer ability to a unit having non-liner optical ability which is 10/1. 1-(4-nitrophenyl)azepane serves as a unit having non-liner optical ability, whereas ethyl carbazole serves as a component having plasticizing ability. Thus, the obtained photorefractive composition has a ratio of a unit having charge transfer ability to a unit having non-liner optical ability which is about 2.3/1 (i.e., (50×10/11)/(50×1/11±30)).

A display medium was prepared using the composition as follows: the composition was dissolved in toluene. After filtering, the solution was dried in an oven at 50° C. under vacuum evaporation for several hours to remove the solvent. The dried material was homogenized mechanically at 130° C. several times so as to obtain a uniform composite, and small pieces (or powder) of the homogenized composite were melted on two ITO (Indium Tin Oxide)-coated glass electrodes, and assembled at 150° C., thereby obtaining a holographic display medium. A three-dimensional holographic display device can be constructed using the holographic display medium.

### Preparation Example 2

A photorefractive composition was prepared in the same manner as in Preparation Example 1 except that 7 FDCST was used in place of 1-(4-nitrophenyl)azepane, and PCBM[C60] was not used. A display medium was prepared in the same manner as in Preparation Example 1.

### Preparation Example 3

A holographic panchromatic silver halide emulsion plate (PFG-03 commercially available from Integraf L.L.C.) was used as a display medium.

### Example 1

By utilizing the prepared display medium, which is described in the section of Preparation Example 1, and the optical device system which is illustrated in FIG. 2 with a first object (object 11), a 3D full-color hologram image of the first object was recorded on the organic display photorefractive medium with the object beam and the three reference beams using a bias voltage of 80 V/μm. In the above, as RGB lasers, a laser module with Red 657 nm 500 mW/Green 532 nm 2000 mW/Blue 457 nm 600 mW was used. After the 3D hologram image was recorded, the image was reproduced without the object beam and displayed on the photorefractive medium on the side opposite to the side upon which the reference beams were incident. It was confirmed that the 3D hologram image was clearly observed on the photorefractive medium without the object beam. The 3D hologram image was then erased by illumination under the uniform three color laser beams and the high bias voltage. There was no residual image left on the photorefractive medium.

Thereafter, by utilizing the same display medium and the same optical device system with a second object, a 3D full-color hologram image of the second object was displayed on the organic display photorefractive medium in the same manner as described above for the first object. The 3D hologram image of the second object was then erased in the same manner as described above for the first object. This writing/reading-erasing-rewriting/reading process (the rewriting process) was repeated over 10000 times, but no substantial image degradation or performance decay was observed.

### Example 2

By utilizing the prepared display medium, which is described in the section of Preparation Example 1, and the optical device system which is illustrated in FIG. 3 with a first object, a 3D full-color hologram image of the first object can be displayed on the organic display photorefractive medium on the side upon which the reference beams are incident. The 3D hologram can be erased by illumination under the uniform three color laser beams and high bias. Thereafter, by utilizing the same display medium and the same optical device system with a second object, a 3D full-color hologram image of the second object can be displayed on the organic display photorefractive medium. The 3D hologram image of the second object is also erasable. This writing/reading-erasing-rewriting/reading process can be repeated over 10000 times without substantial image degradation or performance decay.

### Example 3

By utilizing the prepared display medium, which is described in the section of Preparation Example 1, and the optical device system which is illustrated in FIG. 4 with computer generated input for a first object, a 3D full-color hologram image of the first object can be displayed on the organic display photorefractive medium on the side opposite to the side upon which the reference beams are incident. The 3D hologram can be erased by illumination under the uniform three color laser beams and high bias. Thereafter, by utilizing the same display medium and the same optical device system with computer generated input for a second object, a 3D full-color hologram image of the second object can be displayed on the organic display photorefractive medium. The 3D hologram image of the second object is also erasable. By controlling the computer generated input, it is possible to continuously change the images. This writing/reading-erasing-rewriting/reading process can be repeated over 10000 times without substantial image degradation or performance decay.

### Example 4

By utilizing the prepared display medium, which is described in the section of Preparation Example 1, and the optical device system which is illustrated in FIG. 5 with computer generated input for a first object, a 3D full-color hologram image of the first object can be displayed on the organic display photorefractive medium on the side upon which the reference beams are incident. The 3D hologram can be erased by illumination under the uniform three color laser beams and high bias. Thereafter, by utilizing the same display medium and the same optical device system with computer generated input for a second object, a 3D full-color hologram image of the second object can be displayed on the organic display photorefractive medium. The 3D hologram image of the second object is also erasable. By controlling the computer generated input, it is possible to continuously change the images. This writing/reading-erasing-rewriting/reading process can be repeated over 10000 times without substantial image degradation or performance decay.

### Example 5

By utilizing the prepared display medium, which is described in the section of Preparation Example 1, and the optical device system which is illustrated in FIG. 8 with a first object (object 111), a 3D full-color hologram image of the first object was recorded on the organic display photorefractive medium with the object beam and the single reference beam (the RGB combined reference beam) using a bias voltage of 80 V/μm. In the above, as RGB lasers, a laser module with Red 657 nm 500 mW/Green 532 nm 2000 mW/Blue 457 nm 600 mW was used. After the 3D hologram image was recorded, the image was reproduced without the object beam and displayed on the photorefractive medium on the side opposite to the side upon which the reference beam was incident. It was confirmed that the 3D hologram image was observed on the photorefractive medium without the object beam. However, small cross talk between different lasers was observed (i.e., red/green image of blue grating, red/blue image of green grating, blue/green image of red grating displayed several degrees of angle off the real object), reducing the overall image quality. The 3D hologram was then erased by illumination under the uniform three color laser beams and high bias. There was no residual image left on the photorefractive medium.

Thereafter, by utilizing the same display medium and the same optical device system with a second object, a 3D full-color hologram image of the second object was displayed on the organic display photorefractive medium in the same manner as described above for the first object. However, small cross talk between different lasers was observed (i.e. red/green image of blue grating, red/blue image of green grating, blue/green image of red grating displayed several degree of angle off the real object), reducing the overall image quality. The 3D hologram image of the second object was then erased in the same manner as described above for the first object This writing/reading-erasing-rewriting/reading process was repeated over 10000 times, but no substantial image degradation or performance decay was observed.

### Example 6

By utilizing the prepared display medium, which is described in the section of Preparation Example 1, and the optical device system which is illustrated in each of FIG. 9 with computer generated input for a first object, a 3D full-color hologram image of the first object can be displayed on the organic display photorefractive medium on the side upon which the reference beam is incident. Small cross talk between RGB lasers may be observed. The 3D hologram can be erased by illumination under the uniform three color laser beams and high bias. Thereafter, by utilizing the same display medium and the same optical device system with computer generated input for a second object, a 3D full-color hologram image of the second object can be displayed on the organic display photorefractive medium. The 3D hologram image of the second object is also erasable. This writing/reading-erasing-rewriting/reading process can be repeated over 10000 times without substantial image degradation or performance decay.

### Example 7

By utilizing the prepared display medium, which is described in the section of Preparation Example 1, and the optical device system which is illustrated in each of FIG. 10 with computer generated input for a first object, a 3D full-color hologram image of the first object can be displayed on the organic display photorefractive medium on the side opposite to the side upon which the reference beam is incident. Small cross talk between RGB lasers may be observed. The 3D hologram can be erased by illumination under the uniform three color laser beams and high bias. Thereafter, by utilizing the same display medium and the same optical device system with computer generated input a second object, a 3D full-color hologram image of the second object can be displayed on the organic display photorefractive medium. The 3D hologram image of the second object is also erasable. By controlling the computer generated input, it is possible to continuously change the images. This writing/reading-erasing-rewriting/reading process can be repeated over 10000 times without substantial image degradation or performance decay.

### Example 8

By utilizing the prepared display medium, which is described in the section of Preparation Example 1, and the optical device system which is illustrated in each of FIG. 11 with computer generated input a first object, a 3D full-color hologram image of the first object can be displayed on the organic display photorefractive medium on the side upon which the reference beam is incident. Small cross talk between RGB lasers may be observed. The 3D hologram can be erased by illumination under the uniform three color laser beams and high bias. Thereafter, by utilizing the same display medium and the same optical device system with computer generated input a second object, a 3D full-color hologram image of the second object can be displayed on the organic display photorefractive medium. The 3D hologram image of the second object is also erasable. By controlling the computer generated input, it is possible to continuously change the images. This writing/reading-erasing-rewriting/reading process can be repeated over 10000 times without substantial image degradation or performance decay.

### Comparative Example 1

By utilizing the silver halide display medium, which is described in the section of Preparation Example 3, and the optical device system which is illustrated in FIG. 2 with a first object except that the high-voltage supplier 23 was not used (i.e., the same system as in Example 1 except that no bias was applied and the display medium was different), a 3D full-color hologram image of the first object was recorded without a bias voltage and displayed on the silver halide plate after development, followed by fixing procedures after exposure (according to the manufacture's manual). Although the quality of the 3D hologram image was good, the image was permanent and could not be erased by illumination under the uniform three color laser beams. Therefore, a second object could not be recorded and displayed. This medium was not rewritable.

### Comparative Example 2

By utilizing the silver halide display medium, which is described in the section of Preparation Example 3, and the optical device system which is illustrated in FIG. 8 with a first object except that the high-voltage supplier 116 was not used (i.e., the same system as in Example 5 except that no bias was applied and the display medium was different), a 3D full-color hologram image of the object was recorded without a bias voltage and displayed on the silver halide plate after development, followed by fixing procedures after exposure (according to the manufacture's manual). Although the quality of the 3D hologram image was good, the image was permanent and could not be erased by illumination under the uniform three color laser beams. Therefore, the second object could not be recorded and displayed. This medium was not rewritable.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A three-dimensional holographic display device comprising a holographic display medium constituted by a photorefractive organic composition, and an optical system for recording and reproducing a holographic image using the holographic display medium,
said photorefractive organic composition comprising at least one photorefractive organic polymer having a tri-alkyl amino side-chain group, wherein the tri-alkyl amino side-chain group is selected from the group consisting of the structure shown in general formula group 1: 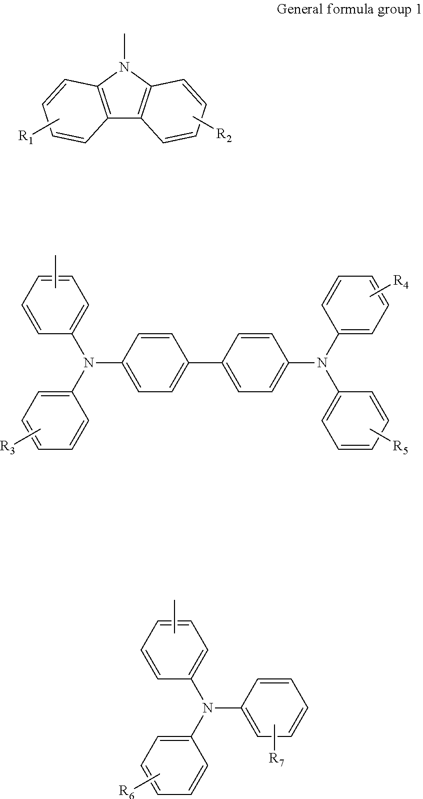
wherein R₁, R₂, R₃, R₄, R₅, R₆, and R₇ are each independently selected from the group consisting of a hydrogen atom, a linear alkyl group with up to 10 carbons, a branched alkyl group with up to 10 carbons, a linear alkyloxy group with up to 10 carbons, a branched alkyloxy group with up to 10 carbons, and an aromatic group with up to 10 carbons.

2. The three-dimensional holographic display device according to claim 1, wherein the holographic display medium is holographically recordable with two or more different color laser beams.

3. The three-dimensional holographic display device according to claim 2, wherein said two or more laser beams are selected from the group consisting of red, green, and blue color laser beams.

4. The three-dimensional holographic display device according to claim 2, wherein the optical system comprises laser sources for emitting the two or more different color laser beams.

5. The three-dimensional holographic display device according to claim 4, wherein the optical system is configured to produce an object beam by splitting each laser beam into first and second split laser beams and combining each first split laser beam and to produce two or more reference beams using the respective second split laser beams, wherein the object beam and the reference beams are incident onto a rear side of the holographic display medium which is opposite to a front side of the holographic display medium for viewing holographic images.

6. The three-dimensional holographic display device according to claim 4, wherein the optical system is configured to produce an object beam by splitting each laser beam into first and second split laser beams and combining each first split laser beam and to produce two or more reference beams using the respective second split laser beams, wherein the object beam is incident onto a rear side of the holographic display medium which is opposite to a front side of the holographic display medium for viewing holographic images, and the reference beams are incident onto the front side of the holographic display medium.

7. The three-dimensional holographic display device according to claim 4, wherein the optical system is configured to produce an object beam by splitting each laser beam into first and second split laser beams and combining each first split laser beam and to produce two or more reference beams using the respective second split laser beams, wherein after combining each first split laser beam, the object beam is reflected off an object being recorded.

8. The three-dimensional holographic display device according to claim 4, wherein the optical system further comprises a spatial light modulator, liquid crystal plate or digital micromirror device arranged for outputting image data to record holographic images on the holographic display medium, wherein the optical system is configured to produce an object beam by splitting each laser beam into first and second split laser beams and combining each first split laser beam and to produce two or more reference beams using the respective second split laser beams, wherein after combining each first split laser beam, the object beam is sent through the spatial light modulator, liquid crystal plate or digital micromirror device.

9. The three-dimensional holographic display device according to claim 1, wherein the holographic display medium is shaped into a sheet which is connected to two electrodes.

10. The three-dimensional holographic display device according to claim 1, wherein the photorefractive organic composition has a ratio of a unit having charge transfer ability to a unit having non-linear optical ability which is between about 4/1 and 1/4 by weight.

11. The three-dimensional holographic display device according to claim 1, wherein the holographic display medium is rewritable.

12. A method of recording and reproducing a holographic image comprising:
(i) recording a holographic image using an optical system by illuminating an object laser beam and at least one reference laser beam onto a holographic display medium while a bias voltage is applied thereto, said holographic display medium constituted by a photorefractive organic composition,
said photorefractive organic composition comprising at least one photorefractive organic polymer having a tri-alkyl amino side-chain group, wherein the tri-alkyl amino side-chain group is selected from the group consisting of the structure shown in general formula group 1: 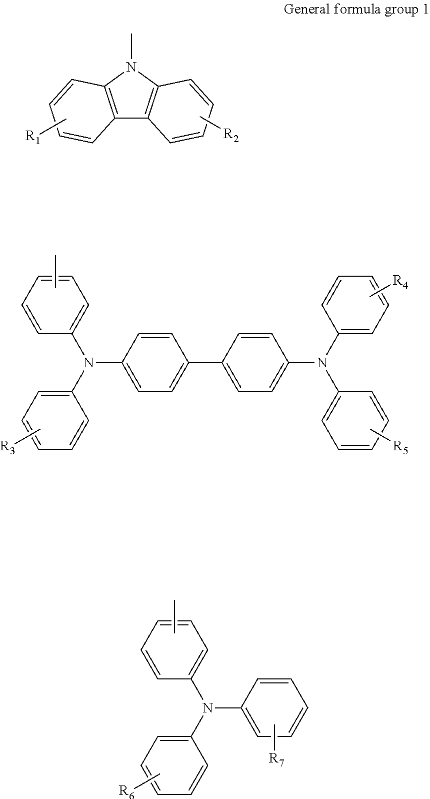
wherein R₁, R₂, R₃, R₄, R₅, R₆, and R₇ are each independently selected from the group consisting of a hydrogen atom, a linear alkyl group with up to 10 carbons, a branched alkyl group with up to 10 carbons, a linear alkyloxy group with up to 10 carbons, a branched alkyloxy group with up to 10 carbons, and an aromatic group with up to 10 carbons; and
(ii) reproducing the holographic image using said optical system by illuminating at least one reference laser beam onto the holographic display medium.

13. The method according to claim 12, wherein the holographic image is recorded and reproduced using two or more different color laser beams.

14. The method according to claim 13, wherein the two or more laser beams are selected from the group consisting of red, green, and blue color laser beams.

15. The method according to claim 13, wherein the object laser beam is produced by splitting each laser beam into first and second split laser beams and combining each first split laser beam, and two or more reference laser beams as the at least one reference laser beam are produced by using the respective second split laser beams, wherein the object laser beam and the reference laser beams are incident onto a rear side of the holographic display medium which is opposite to a front side of the holographic display medium for viewing holographic images.

16. The method according to claim 13, wherein the object laser beam is produced by splitting each laser beam into first and second split laser beams and combining each first split laser beam, and two or more reference laser beams as the at least one reference laser beam are produced by using the respective second split laser beams, wherein the object laser beam is incident onto a rear side of the holographic display medium which is opposite to a front side of the holographic display medium for viewing holographic images, and the reference laser beams are incident onto the front side of the holographic display medium.

17. The method according to claim 13, wherein the object laser beam is produced by splitting each laser beam into first and second split laser beams and combining each first split laser beam, and two or more reference laser beams as the at least one reference laser beam are produced by using the respective second split laser beams, wherein after combining each first split laser beam, the object laser beam is reflected off an object being recorded.

18. The method according to claim 13, wherein the object laser beam is produced by splitting each laser beam into first and second split laser beams and combining each first split laser beam, and two or more reference laser beams as the at least one reference laser beam are produced by using the respective second split laser beams, wherein after combining each first split laser beam, the object beam is sent through a spatial light modulator, liquid crystal plate or digital micromirror device.

19. The method according to claim 12, further comprising (iii) erasing the recorded holographic image by illuminating the at least one reference laser beam to the holographic display medium while a bias voltage is applied thereto.

20. The method according to claim 19, wherein steps (i) through (iii) are repeated more than 3,000 times.
